(19) United States
(12) Patent Application Publication
(10) Pub. No.: US 2006/0082706 A1
(43) Pub. Date: Apr. 20, 2006

(54) Array substrate, color filter substrate, and liquid crystal display panel having the array substrate and the color filter substrate

(75) Inventors: Dae-Ho Choo, Yongin-si (KR); Ho-Min Kang, Suwon-si (KR); Jae-Hoon Hwang, Seoul (KR); Jeong-Min Oh, Seoul (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/215,069

(22) Filed: Aug. 29, 2005

(30) Foreign Application Priority Data
Oct. 20, 2004 (KR) 2004-84128

(51) Int. Cl. G02F 1/1335

(52) U.S. Cl. 349/114

(57) ABSTRACT

A display apparatus includes at least one pixel region having a reflection region and a transmission region. A polarizing layer of the pixel region may be formed on an uneven underlying structure surface, and may have an even opposing surface. The polarizing layer may have a first thickness the reflection area of the pixel region and a second, substantially larger thickness in the transmission area of the pixel region. The display apparatus may comprise an array substrate, a color filter substrate, and a liquid crystal material. In an array substrate, a color filter substrate and a liquid crystal display panel having the array substrate and the color filter substrate, an array substrate includes a first inner polarizing layer having a first portion where a front light is reflected and a second portion through which a back light passes. The second portion is substantially thicker than the first portion. The color filter substrate includes a second inner polarizing layer. A liquid crystal layer is positioned between the array substrate and the color filter substrate. The array substrate and the color filter substrate are combined with each other to form the liquid crystal display panel.

### CROSS REFERENCE TO RELATED APPLICATION

This application claims priority under 35 USC § 119 to Korean Patent Application No. 2004-84128 filed on Oct. 20, 2004, the disclosure of which is herein incorporated by reference in its entirety.

### BACKGROUND OF THE INVENTION

1. Field of the Invention

The present invention relates to displays; for example to an array substrate, a color filter substrate and a liquid crystal display panel having the array substrate and the color filter substrate. More particularly, some embodiments of the present invention relate to an array substrate including a first inner polarizing layer having a substantially even upper face, a color filter substrate including a second inner polarizing layer having a substantially even lower face and a liquid crystal display panel including the array substrate and the color filter substrate.

2. Description of the Related Art

A liquid crystal display device may be a reflective type device (which uses incident natural light), or a transmissive type device (which uses an artificial backlight). For a reflective type device, if the amount of available natural light is small, the display quality may decrease. In contrast, a transmissive type device allows a substantially constant amount of light. However, the backlight assembly consumes a substantial amount of power during operation. Thus, a transmissive type liquid crystal display device may not be suitable for a portable display device that uses a battery as a power source.

A liquid crystal display device incorporating both transmission and reflection may overcome some disadvantages of single type devices. In general, a liquid crystal display device is manufactured using a common process, independent of the size of the liquid crystal display device.

For example, an LCD device may be manufactured by forming an array substrate and a color filter substrate. The array substrate and the color filter substrate are connnected, then the array substrate and the color filter substrate are partially cut. Subsequently, a liquid crystal material is introduced between the array substrate and the color filter substrate. Thereafter, at least one polarizing layer is attached to the array substrate and the color filter substrate. A module process is then performed on the array substrate and the color filter substrate.

In another example of an LCD manufacturing process, liquid crystal material is introduced between the array substrate and the color filter substrate. Subsequently, a vacuum process is performed on the array substrate and the color filter substrate. Thereafter, the array substrate and the color filter substrate are partially cut. At least one polarizing layer is then attached to the array substrate and the color filter substrate. Thereafter, a module process is performed on the array substrate and the color filter substrate.

Performing a larger number of manufacturing steps prior to the cutting step may result in increased yields for small liquid crystal display device manufacturing processes. One way in which to increase the number of steps performed prior to cutting is to attach the polarizing layer to the array substrate and the color filter substrate prior to the cutting process. This may be accomplished by forming the polarizing layer using a coating process performed during formation of the array substrate and the color filter substrate.

### SUMMARY OF THE INVENTION

Systems and techniques described herein may allow for increased manufacturing yields by allowing one or more polarizing layers to be formed prior to a cutting process.

In general, in one aspect, the present disclosure provides an array substrate including an inner polarizing layer having a substantially even upper face.

The present disclosure also provides a color filter substrate including a color filter substrate having a substantially even lower face.

The present disclosure also provides a liquid crystal display panel including the above array substrate and the above color filter substrate.

In accordance with one aspect of the present invention, an array substrate includes a transparent substrate, a pixel electrode layer, a reflection layer and an inner polarizing layer. The transparent substrate has a pixel area comprising a reflection area and a transmission area. The pixel electrode layer corresponds to the pixel area. The reflection layer corresponds to the reflection area. The inner polarizing layer corresponds to the pixel electrode layer and the reflection layer. The inner polarizing layer has a first portion and a second portion. The first portion corresponds to the reflection area. The second portion corresponds to the transmission area. The second portion is substantially thicker than the first portion.

In accordance with another aspect of the present invention, a color filter substrate includes a transparent layer, a color pixel layer and an inner polarizing layer. The transparent layer has a pixel area divided into a reflection area and a transmission area. The color pixel layer is formed under the transparent layer. The color pixel layer corresponds to the pixel area. The inner polarizing layer corresponds to the color pixel layer. The inner polarizing layer has a substantially even lower face.

In accordance with still another aspect of the present invention, a liquid crystal display panel includes a first substrate, a liquid crystal layer and a second substrate. The first substrate includes a first transparent layer, a pixel electrode, a reflection layer and a first inner polarizing layer. The first transparent layer has a pixel area comprising a reflection area and a transmission area. The pixel electrode layer corresponds to the pixel area. The reflection layer corresponds to the reflection area. The first inner polarizing layer corresponds to the pixel electrode layer and the reflection layer. The first inner polarizing layer has a first portion and a second portion. The first portion corresponds to the reflection area. The second portion corresponds to the transmission area. The second portion is substantially thicker than the first portion. The second substrate includes a second transparent layer and a second inner polarizing layer. The second inner polarizing layer corresponds to the pixel area. The second substrate is combined with the first substrate to receive the liquid crystal layer between the first substrate and the second substrate.

According to some embodiments, an inner polarizing layer is formed by a coating step while an array substrate and a color filter substrate are manufactured. In addition, the inner polarizing layer has a first portion where a front light is reflected and a second portion through which a back light passes. Because the second portion is substantially thicker than the first portion, both a reflection mode characteristic and a transmission mode characteristic are improved.

In general, in another aspect, a display apparatus may include a first pixel region with a reflection region and a transmission region. A first pixel electrode configured to provide a pixel voltage of a pixel voltage difference across a display material may be included in the first pixel region. At least one display characteristic of the display material (e.g., a liquid crystal material) is different for a first pixel potential difference and a second pixel potential difference.

The apparatus may further include a polarizing layer of the first pixel region. The polarizing layer may include an anisotropic polarizing material. The polarizing layer may have a first portion included in the reflection region of the first pixel region and a second portion included in the transmission region of the first pixel region. The polarizing layer of the first pixel region may have a first thickness in the reflection region of the first pixel region and a second greater thickness in the transmission region of the first pixel region. The polarizing layer may have a substantially even surface, and a substantially uneven opposite surface covering underlying structures. The polarizing layer may be formed using a coating method, such as a slot coating method.

### BRIEF DESCRIPTION OF THE DRAWINGS

The above and other advantages of the present invention will become readily apparent by reference to the following detailed description when considered in conjunction with the accompanying drawings in which:

FIG. 1 a cross-sectional view illustrating a transmissive and reflective type liquid crystal display panel including a dual thickness inner polarizing layer in accordance with an exemplary embodiment of the present invention;

FIG. 2 is a conceptual view illustrating a method of forming the first and second inner polarizing layers of FIG. 1 using a coating device, in accordance with an exemplary embodiment of the present invention;

FIGS. 3A and 3B are perspective views illustrating a method of forming polarization layers such as the first and second inner polarizing layers in FIG. 1 by a coating device in accordance with another exemplary embodiment of the present invention;

FIG. 4 is a cross-sectional view illustrating a transmissive and reflective type LCD panel having a dual thickness inner polarizing layer in accordance with an exemplary embodiment of the present invention;

FIG. 5 is a cross-sectional view illustrating a transmissive and reflective type LCD panel having a dual thickness inner polarizing layer;

FIG. 6 is a cross-sectional view illustrating a transmissive and reflective type LCD panel having a dual thickness inner polarizing layer in accordance with an exemplary embodiment of the present invention; and

FIG. 7 is a block diagram illustrating a LCD device in accordance with an exemplary embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully describe the invention to those skilled in the art. In the drawings, the size and relative sizes of layers and regions may be exaggerated for clarity. It will be understood that when an element or layer is referred to as being “on” or “connected to” another element or layer, it can be directly on or directly connected to the other element or layer or intervening elements or layers may be present.

Like reference numerals refer to like elements throughout.

It will be understood that, although the terms first, second, etc. may be used herein to describe various elements, components or layers, these elements, components or layers should not be limited by these terms. These terms are only used to distinguish one element, component or layer from another element, component or layer. Thus, a first element, component or layer discussed below could be termed a second element, component or layer without departing from the teachings of the present invention. Further, a “first” or other numbered element does not imply that “second” or additional elements are needed.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, elements or components, but do not preclude the presence or addition of one or more other features, elements or components.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Various embodiments of the present invention will now be described with reference to the accompanying drawings.

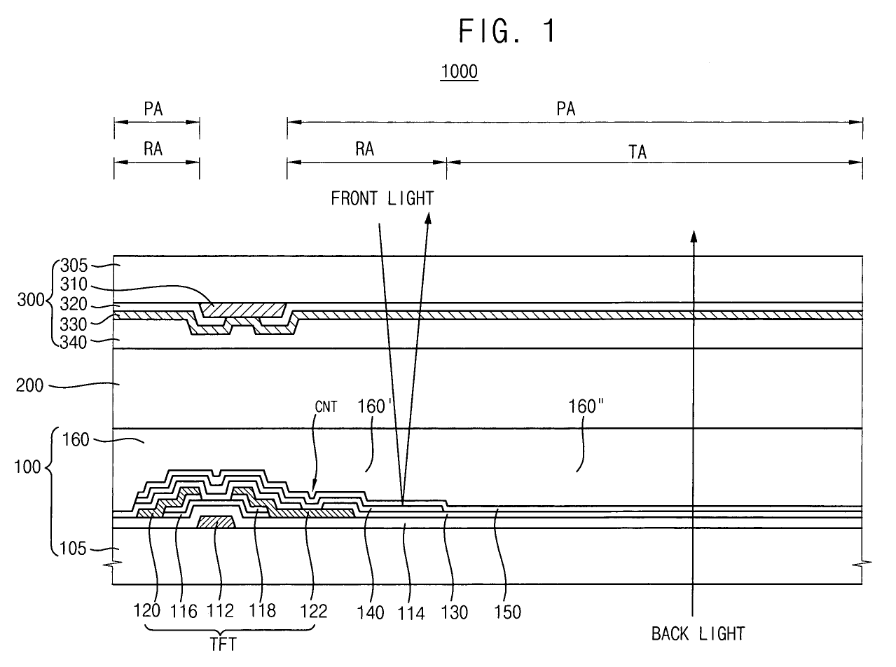

FIG. 1 a cross-sectional view illustrating a transmissive and reflective type liquid crystal display panel including a dual thickness inner polarizing layer, in accordance with an exemplary embodiment. In particular, a liquid crystal layer included in the transmissive and reflective type liquid crystal display (LCD) panel has a substantially uniform thickness. That is, the liquid crystal layer has a single cell-gap. The liquid crystal layer is positioned on a substantially even upper face of a first inner polarizing layer.

Referring to FIG. 1, a transmissive and reflective type LCD panel 1000 includes an array substrate 100, a liquid crystal layer 200 and a color filter substrate 300. The color filter substrate 300 is connected to the array substrate 100 to receive the liquid crystal layer 200 between the color filter substrate 300 and the array substrate 100.

The array substrate 100 includes a first transparent layer 105, a gate electrode 112 and a gate insulation layer 114. The gate electrode 112 extends from a gate wire (not shown) formed on the first transparent layer 105. The gate insulation layer 114 covers the gate wire and the gate electrode 112. The gate insulation layer 114 may include an insulation material such as silicon nitride (SixNy).

Examples of conductors that can be used for the gate wire may include aluminum (Al), silver (Ag), copper (Cu), molybdenum (Mo), chromium (Cr), tantalum (Ta) and titanium (Ti). These (and/or other conductive materials) may be used alone or in a mixture thereof.

Conductive materials that can be used for the gate electrode 112 include aluminum (Al), silver (Ag), copper (Cu), molybdenum (Mo), chromium (Cr), tantalum (Ta) and titanium (Ti). These (and/or other conductive materials) may be used alone or in a mixture thereof.

The array substrate 100 includes an amorphous silicon layer 116, an N+ amorphous silicon layer 118, a source electrode 120 and a drain electrode 122. The amorphous silicon layer 116 covers the gate electrode 112. The N+ amorphous silicon layer 118 is formed on the amorphous silicon layer 116. The source electrode 120 partially covers the N+ amorphous silicon layer 118. The drain electrode 122 also partially covers the N+ amorphous silicon layer 118. The source electrode 120 and the drain electrode 122 are spaced apart from each other.

A thin film transistor (TFT) includes the gate electrode 112, the amorphous silicon layer 116, the N+ amorphous silicon layer 118, the source electrode 120 and the drain electrode 122.

Examples of conductors that can be used for the source electrode 120 include aluminum (Al), silver (Ag), copper (Cu), molybdenum (Mo), chromium (Cr), tantalum (Ta) and titanium (Ti). These (and/or other conductors) may be used alone or in a mixture thereof.

Conductors that can be used for the drain electrode 122 include (for example) aluminum (Al), silver (Ag), copper (Cu), molybdenum (Mo), chromium (Cr), tantalum (Ta) and titanium (Ti). These (and/or other conductors) may be used alone or in a mixture thereof.

The gate electrode 112 and the source electrode 120 may have a single-layered structure or a double-layered structure.

For a single-layered structure, the gate electrode 112 or the source electrode (or both) 120 may include conductors such as aluminum, neodymium and copper. The conductive materials may be used alone, or in a mixture thereof. As one example, the gate electrode 112 or the source electrode 120 (or both) may include an alloy of aluminum and neodymium.

If the gate electrode 112 and/or the source electrode 120 has a double-layered structure, the gate electrode 112 or the source electrode 120 may include a lower layer and an upper layer. The lower layer may include a first material having substantially high physical and chemical characteristics. For example, the first material may be chromium (Cr) or molybdenum (Mo), or mixtures including these elements. The upper layer may include a second material having a substantially low resistivity. For example, the second material may be aluminum (Al).

The array substrate 100 includes a passivation layer 130 and a reflection layer 140. The passivation layer 130 partially covers the TFT. The passivation layer 130 may partially expose the drain electrode 122. The reflection layer 140 partially covers the passivation layer 130.

The passivation layer 130 protects portions of the amorphous silicon layer 116 and the N+ amorphous silicon layer 118 exposed between the source electrode 120 and the drain electrode 122. In addition, the passivation layer 130 electrically insulates the TFT from the reflection layer 140.

The array substrate 100 includes a pixel electrode layer 150 and a first inner polarization layer 160. The pixel electrode layer 150 is electrically connected to the drain electrode 122 of the TFT through a contact hole CNT. The first inner polarization layer 160 covers the pixel electrode layer 150.

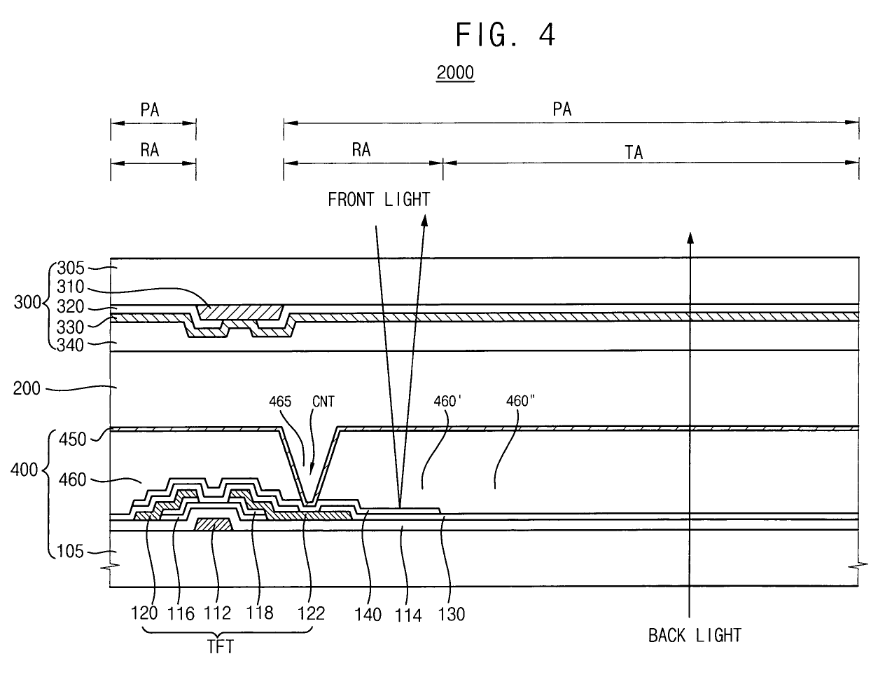

The pixel electrode layer 150 corresponds to a pixel area PA, which includes a reflection area RA and a transmission area TA. As illustrated in FIG. 1, the pixel electrode layer 150 corresponds to the pixel area PA. However, the pixel electrode layer 150 may selectively correspond to the transmission area and may be electrically connected to the reflection layer 140, as shown in FIG. 4.

The first inner polarizing layer 160 covers the reflection layer 140 and the pixel electrode layer 150. The first inner polarizing layer 160 has a first portion 160′ and a second portion 160″. The first portion 160′ corresponds to the reflection area RA. The first portion 160′ has a first thickness. The second portion 160″ corresponds to the transmission area TA. The second portion 160″ has a second thickness. The second thickness is substantially larger than the first thickness.

The first thickness and the second thickness are from about 0.4 μm to about 0.6, μm and from about 0.8 μm to about 1.2 μm, respectively. Preferably, the first thickness and the second thickness are about 0.5 μm and about 1.0 μm, respectively.

The color filter substrate 300 includes a second transparent layer 305, a light blocking layer 310, a color pixel layer 320, a common electrode layer 330 and a second inner polarizing layer 340. The transparent layer 305 is formed beneath the second transparent layer 305 to define the pixel area PA. The color pixel layer 320 corresponds to the pixel area PA. The second inner polarizing layer 340 is formed beneath the common electrode layer 330 so that the common electrode layer 330 may be covered with the second inner polarizing layer 340.

Although not shown in FIG. 1, an over-coating layer may be formed beneath the color pixel layer 320 so that the color pixel layer 320 may be covered with the over-coating layer.

The first polarizing layer 160 has a first polarizing axis, and the second polarizing layer 340 has a second polarizing axis. The first polarizing axis may be perpendicular to the second polarizing axis. For example, if the first polarizing axis is a vertical polarizing axis, the second polarizing axis may be a horizontal axis.

Thin crystal films (TCF™) produced by Optiva, inc. USA may be used as the first polarizing layer 160 and the second inner polarizing layer 340. TCF™ is an anisotropic polarizing layer including a dyestuff formed using a chromogen base. Other polarizing materials may be used as the first polarizing layer 160 and the second inner polarizing layer 340.

Table 1 shows an isotropic characteristic of the TCF™.

TABLE 1

| Sample | Transparency | H90 | H0 | Efficiency | Contrast |
|---|---|---|---|---|---|
| No. | (%) | (%) | (%) | (%) | ratio (%) |
| 1 | 40.45 | 1.32 | 31.41 | 95.87 | 23.74 |
| 2 | 30.02 | 0.08 | 29.65 | 97.32 | 36.86 |
| 3 | 39.12 | 0.90 | 29.71 | 97.02 | 33.10 |
| 4 | 38.35 | 0.58 | 28.84 | 98.01 | 49.65 |
| 5 | 38.55 | 0.55 | 29.17 | 98.14 | 53.32 |
| 6 | 35.67 | 0.11 | 25.34 | 99.58 | 235.98 |
| 7 | 37.92 | 0.37 | 28.38 | 98.70 | 76.40 |
| 8 | 37.02 | 0.33 | 27.08 | 98.79 | 82.11 |
| 9 | 34.61 | 0.11 | 23.85 | 99.54 | 215.65 |

Here, a thickness of the TCF is substantially in proportion to the number of samples.

In Table 1, “H0” indicates a parallel transparency. The parallel transparency is measured when the first polarizing axis is substantially in parallel with the second polarizing axis. “H90” indicates a perpendicular transparency. The perpendicular transparency is measured when the first polarizing axis is substantially perpendicular to the second polarizing axis.

As shown in Table 1, the transparency, the parallel transparency (H0), the perpendicular transparency (H90) and the contrast ratio (C/R) vary with the thickness of the TCF.

For example, as the thickness of the TCF increases, the transparency, the parallel transparency (H0) and the perpendicular transparency (H90) may decrease. However, the contrast ratio (C/R) may increase.

On the other hand, as the thickness of the TCF decreases, the transparency, the parallel transparency (H0) and the perpendicular transparency (H90) may increase. However, the contrast ratio (C/R) may decrease.

Anisotropic thin crystal films (TCFs) may be efficiently employed as the first polarizing layer 160 and the second inner polarizing layer 340 that are included in the transmissive and reflective type LCD panel.

When an inner polarizing layer is employed, a transmission mode characteristic and a reflection characteristic may be improved without the aid of an additional mask.

In a reflection mode, the reflection characteristic may be determined by the parallel transparency (H0) and the perpendicular transparency (H90), rather than the contrast ratio (C/R). In a transmission mode, the transmission characteristic may be determined by the contrast ratio (C/R), rather than the parallel transparency (H0) and the perpendicular transparency (H90).

Thus, when a thin film such as TCF is employed as the inner polarizing layer, the first portion and the second portion of the inner polarizing layer may have relatively high transparency and high contrast ratio, respectively. As a result, both the reflection characteristic and the transmission characteristic may be improved.

A polymer resin in a liquid gel state may be coated to form the TCF. The polymer resin may have physical characteristics substantially the same as those of a photoresist material. For example, the polymer resin may have a viscosity of about 300 psi. Thus, the TCF may be formed by using a coating device.

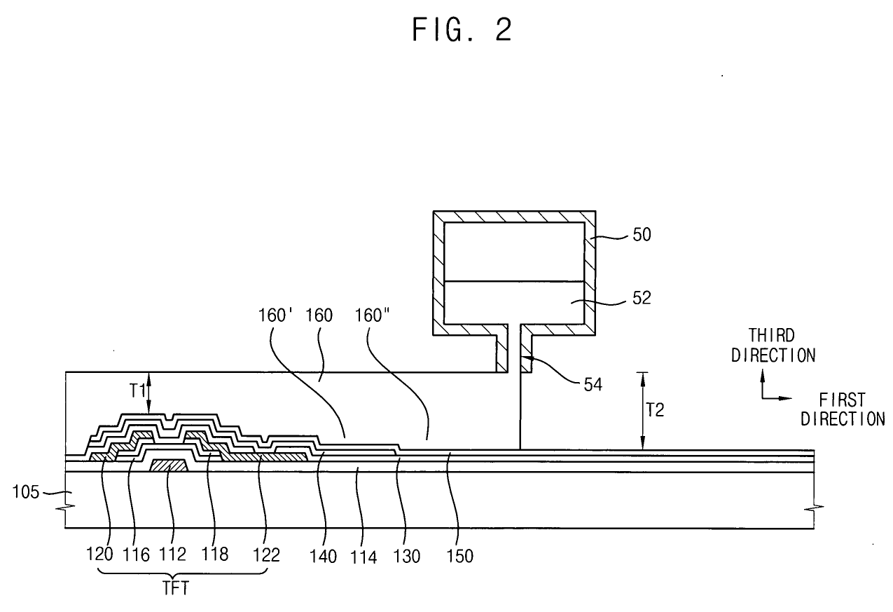

FIG. 2 is a conceptual view illustrating a method of forming the first and second inner polarizing layers of FIG. 1 using a coating device, in accordance with an exemplary embodiment of the present invention. FIG. 2 illustrates a method of forming the first and second inner polarizing layers using a slot die coating method. However, other methods may be used.

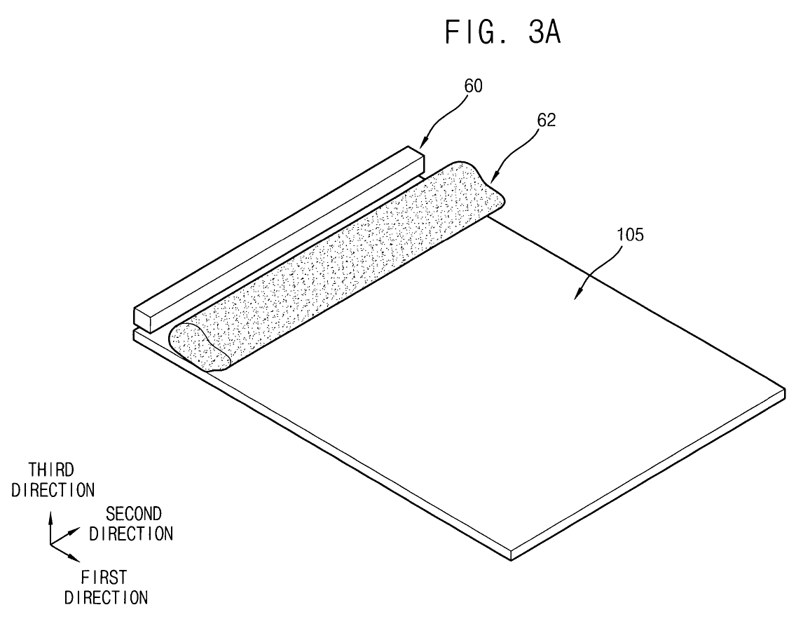

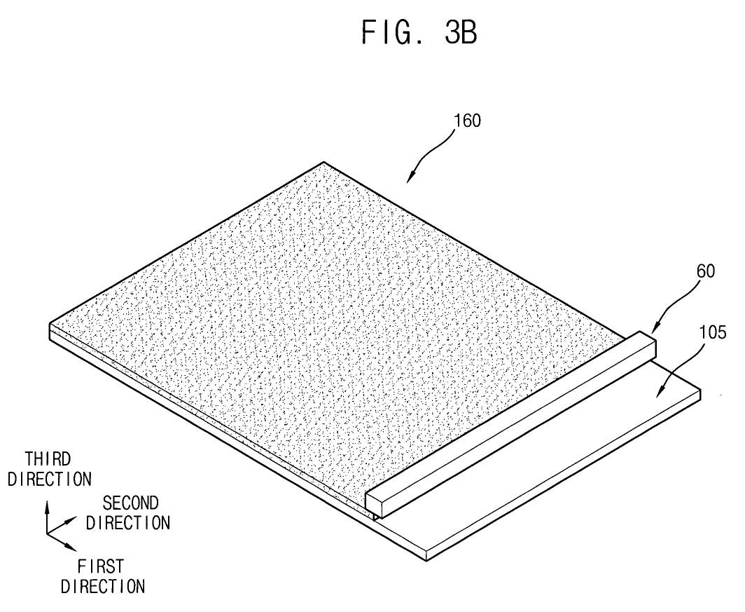

Referring to FIG. 2, a coating device includes a nozzle head 50. The nozzle head 50 extends in a third direction (see FIG. 3A). An outlet 54 protrudes downward from a lower portion of the nozzle head 50. Polymer resin 52 from nozzle head 50 is provided to a surface of pixel electrode layer 150 to form first polarizing layer 160.

The nozzle head 50 is displaced from the first transparent layer 105 along the third direction. Polymer resin 52 is coated on pixel electrode layer 150 as nozzle head 50 moves in a plane parallel to the first transparent layer 150. Thus, polarizing layer 160 is formed on first transparent layer 150. Using this method, the upper face of the polarizing layer 160 is substantially even.

The first inner polarizing layer 160 includes the first portion 160′ and the second portion 160″. The first portion 160′ corresponds to the reflection area RA. The first portion 160′ has a first thickness T1. The second portion 160″ corresponds to the transmission area TA. The second portion 160″ has a second thickness T2. The second thickness T2 is substantially larger than the first thickness T1.

Referring to FIGS. 1 and 2, the second inner polarizing layer 340 may be formed on the common electrode layer 330 by using a method substantially identical to that already illustrated in FIG. 2 and described above. Thus, further explanation will be omitted.

FIGS. 3A and 3B are perspective views illustrating a method of forming the first and second inner polarizing layers in FIG. 1 by a coating device in accordance with another exemplary embodiment of the present invention.

Referring to FIG. 3A, a polymer resin is dispensed on a first transparent layer 105 so that a clot 62 of the polymer resin may be formed on the first transparent layer 105. Although not illustrated in FIG. 3A, upper structures such as the gate insulation layer 114, the TFT, the passivation layer 130, the reflection layer 140 and the pixel electrode layer 150 are formed on the first transparent layer 105.

Referring to FIG. 3A, a slot 60 is separated from the first transparent layer 105 by a predetermined distance. The slot 60 moves substantially parallel to the first transparent layer 105 in a first direction. The slot 60 enables the clot 62 of the polymer resin to spread on the first transparent layer 105, forming the first polarizing layer 160.

Because the slot 60 moves substantially in parallel with the first transparent layer 105, an upper face of the first polarizing layer 160 may be substantially even. That is, the upper structures formed on the first transparent layer 105 may hardly affect a shape of the upper face of the transparent layer 105.

Referring to FIGS. 1, 3A and 3B, the second inner polarizing layer 340 may be formed on the common electrode layer 330 by using a method substantially identical to that illustrated in FIGS. 3A and 3B, and described above. Thus, further explanation will be omitted.

As described above, first and second inner polarizing layers 160 and 340 with substantially even upper faces may be formed by the slot die coating method (for example). This allows for stable positioning of liquid crystal layer 200 between the upper faces of the first and second inner polarizing layers 160 and 340. This may increase both the yield and display quality of the LCD devices.

A transmissive and reflective type LCD panel may operate as follows. The operation of the transmissive and reflective type LCD panel may include a transmission mode operation and a reflection mode operation. In the absence of a potential difference applied to the liquid crystal layer 200, the transmissive and reflective type LCD panel 1000 displays white. This may be referred to as a “normally white” mode. In addition, the first inner polarizing layer 160 may have a vertical polarizing axis, while the second inner polarizing layer 340 has a horizontal polarizing axis, respectively.

Transmission Mode Operation

In transmission mode, artificial light is provided to the LCD display device. For example, a back light may generate light incident on a rear face of the transmissive and reflective LCD panel 1000. The back light includes a vertically polarized ray and a horizontally polarized ray.

The vertically polarized ray may be substantially transmitted through the first inner polarizing layer 160 having the vertical polarizing axis. However, the vertically polarized ray may be substantially blocked by the second inner polarizing layer 340 having the horizontal polarizing axis.

On the other hand, the horizontally polarized ray may be substantially transmitted through the second inner polarizing layer 340 having the horizontal polarizing axis, while being substantially blocked by the first inner polarizing layer 160 having the vertical polarizing axis.

The first inner polarizing layer 160 included in the array substrate 100 provides the liquid crystal layer 200 with the vertically polarized ray of the back light. To display white, the liquid crystal layer 200 delays a wavelength of the vertically polarized ray by about λ/2 to change the vertically polarized ray into the horizontally polarized ray, and the horizontally polarized ray is transmitted to the second inner polarizing layer 340. To display black, the vertically polarized ray may pass through the liquid crystal layer 200 without a delay of the wavelength so that the vertically polarized ray may be incident on the second inner polarizing layer 340.

When a potential difference is not applied to the liquid crystal layer 200, the liquid crystal layer 200 delays the wavelength of the vertically polarized ray by about λ/2 to change the vertically polarized ray into the horizontally polarized ray. The horizontally polarized ray passes through the second inner polarizing layer 340, the common electrode layer 330, the color pixel layer 320 and the second transparent layer 305. As a result, the transmissive and reflective LCD panel 1000 may display white.

If an electric potential difference is applied to the liquid crystal layer 200, the vertically polarized ray may pass through the liquid crystal layer 200 without the delay of the wavelength so that the vertically polarized ray may be incident on the second inner polarizing layer 340. Because the vertically polarized ray is substantially blocked by the second inner polarizing layer 340 having the horizontal polarizing axis, the transmissive and reflective LCD panel 1000 may display black.

Reflection Mode Operation

In reflection mode, a front light (e.g., natural light) is incident on a front face of the transmissive and reflective LCD panel 1000. The front light includes a vertically polarized ray and a horizontally polarized ray.

The vertically polarized ray may be substantially transmitted through the first inner polarizing layer 160 having the vertical polarizing axis. However, the vertically polarized ray may be substantially blocked by the second inner polarizing layer 340 having the horizontal polarizing axis.

On the other hand, the horizontally polarized ray may be substantially transmitted through the second inner polarizing layer 340 having the horizontal polarizing axis, while the horizontally polarized ray may be substantially blocked by the first inner polarizing layer 160 having the vertical polarizing axis.

The front light sequentially passes through the second transparent layer 305, the color pixel layer 320 and the common electrode 330 that are included in the color filter substrate 300. The front light is then incident on the second inner polarizing layer 340.

The second inner polarizing layer 340 provides the liquid crystal layer 200 with the horizontally polarized ray included in the front light. To display white, the liquid crystal layer 200 delays a wavelength of the horizontally polarized ray by about λ/2 to change the horizontally polarized ray into the vertically polarized ray and then provides the first inner polarizing layer 160 with the vertically polarized ray. To display black, the horizontally polarized ray may pass through the liquid crystal layer 200 without a delay of the wavelength so that the horizontally polarized ray may be incident on the first inner polarizing layer 160.

When a potential difference is not applied to the liquid crystal layer 200, the liquid crystal layer 200 delays the wavelength of the horizontally polarized ray by about λ/2 to change the horizontally polarized ray into the vertically polarized ray. Thereafter, the vertically polarized ray sequentially passes through the first inner polarizing layer 160 and the pixel electrode layer 150. The vertically polarized ray may be then reflected on the reflection layer 140. Thereafter, the vertically polarized ray may sequentially pass through the pixel electrode layer 150 and the first inner polarizing layer 460. The liquid crystal layer 200 then delays the wavelength of the vertically polarized ray by about λ/2 to change the vertically polarized ray into the horizontally polarized ray. Sequentially, the horizontally polarized ray passes through the second inner polarizing layer 340, the common electrode layer 330, the color pixel layer 320 and the second transparent layer 305. As a result, the transmissive and reflective LCD panel 1000 may display white.

If an electric potential difference is applied to the liquid crystal layer 200, the second inner polarizing layer 340 provides the liquid crystal layer 200 with the horizontally polarized ray. Then, the horizontally polarized ray may pass through the liquid crystal layer 200 without the delay of the wavelength so that the vertically polarized ray may be incident on the first inner polarizing layer 160. Because the horizontally polarized ray may be substantially blocked by the first inner polarizing layer 340 having the vertical polarizing axis, the transmissive and reflective LCD panel 1000 may display black.

In FIG. 1, the transmissive and reflective type LCD panel is illustrated as an LCD panel. However, other configurations of an LCD panel may be used. For example, a transmissive type LCD or a reflective LCD panel may be used as the LCD panel. The transmissive type LCD may omit the reflection layer. On the other hand, the reflective type LCD may include a reflection layer corresponding to an entire pixel area.

FIG. 4 is a cross-sectional view illustrating a transmissive and reflective type LCD panel having a dual thickness inner polarizing layer in accordance with an exemplary embodiment of the present invention. In particular, a liquid crystal layer included in the transmissive and reflective type liquid crystal display (LCD) panel has a substantially uniform thickness. That is, in some embodiments, the liquid crystal layer has a single cell-gap. The liquid crystal layer is positioned on a substantially even upper face of a first inner polarizing layer.

As shown in FIG. 4, transmissive and reflective LCD panel 2000 is substantially identical to that already illustrated in FIG. 1 except for an array substrate 400 having a first inner polarizing layer 460 and a pixel electrode layer 450. Thus, the same reference numerals will be used to refer to the same or like parts as those described in FIG. 1, and repetitive explanation thereof may be omitted.

Referring to FIG. 4, the transmissive and reflective LCD panel 2000 includes the array substrate 400 having the first inner polarizing layer 460 and the pixel electrode layer 450.

The first inner polarizing layer 460 is formed on a passivation layer 130 and a reflection layer 140 so that the passivation layer 130 and the reflection layer 140 are covered with the first inner polarizing layer 460.

The pixel electrode layer 450 is formed between a liquid crystal layer 200 and the first inner polarizing layer 460. The first inner polarizing layer 460 has a contact hole 465.

An inner side face of the contact hole 465 is covered with the pixel electrode layer 450. Thus, the pixel electrode layer 450 may be electrically connected to a reflection layer 140 that is electrically connected to a drain electrode 122 of a TFT.

The first inner polarizing layer 460 has a first portion 460′ and a second portion 460″. The first portion 460′ corresponds to a reflection area RA. The first portion 460′ has a first thickness. The second portion 460″ corresponds to a transmission area TA. The second portion 460″ has a second thickness. The second thickness is substantially larger than the first thickness.

Hereinafter, an operation of the transmissive and reflective type LCD panel 2000 is described. The operation of the transmissive and reflective type LCD panel 2000 may include a transmission mode operation and a reflection mode operation. When a voltage is not applied to the liquid crystal layer 200, the transmissive and reflective type LCD panel 2000 may display white. That is, the transmissive and reflective type LCD panel 2000 may operate in what is referred to as a “normally white” mode. The first inner polarizing layer 160 may have a vertical polarizing axis, while the second inner polarizing layer 340 may have a horizontal polarizing axis.

Transmission Mode Operation

A back light is incident on a rear face of the transmissive and reflective LCD panel 2000. The back light includes a vertically polarized ray and a horizontally polarized ray.

The vertically polarized ray may be substantially transmitted through the first inner polarizing layer 460 having the vertical polarizing axis. However, the vertically polarized ray may be substantially blocked by the second inner polarizing layer 340 having the horizontal polarizing axis.

On the other hand, the horizontally polarized ray may be substantially transmitted through the second inner polarizing layer 340 having the horizontal polarizing axis. However, the horizontally polarized ray may be substantially blocked by the first inner polarizing layer 460 having the vertical polarizing axis.

The first inner polarizing layer 460 included in the array substrate 100 provides the pixel electrode layer 450 with the vertically polarized ray of the back light. The vertically polarized ray then passes through the pixel electrode layer 450. The vertically polarized ray is then incident on the liquid crystal layer 200. To display white, the liquid crystal layer 200 delays a wavelength of the vertically polarized ray by about λ/2 to change the vertically polarized ray into the horizontally polarized ray and then provides the second inner polarizing layer 340 with the horizontally polarized ray. To display black, the vertically polarized ray may pass through the liquid crystal layer 200 without a delay of the wavelength so that the vertically polarized ray may be incident on the second inner polarizing layer 340.

When a potential difference is not applied to the liquid crystal layer 200, the liquid crystal layer 200 delays the wavelength of the vertically polarized ray by about λ/2 to change the vertically polarized ray into the horizontally polarized ray. The horizontally polarized ray passes through the second inner polarizing layer 340, the common electrode layer 330, the color pixel layer 320 and the second transparent layer 305. As a result, the transmissive and reflective LCD panel 2000 may display white.

If an electric potential difference is applied to the liquid crystal layer 200, the vertically polarized ray may pass through the liquid crystal layer 200 without the delay of the wavelength, so that the vertically polarized ray may be incident on the second inner polarizing layer 340. Because the vertically polarized ray is substantially blocked by the second inner polarizing layer 340 having the horizontal polarizing axis, the transmissive and reflective LCD panel 1000 may display black.

Reflection Mode Operation

In reflection mode, a front light is incident on a front face of the transmissive and reflective LCD panel 2000. The front light includes a vertically polarized ray and a horizontally polarized ray.

The vertically polarized ray may be substantially transmitted through the first inner polarizing layer 460 having the vertical polarizing axis. However, the vertically polarized ray may be substantially blocked by the second inner polarizing layer 340 having the horizontal polarizing axis.

On the other hand, the horizontally polarized ray may be substantially transmitted through the second inner polarizing layer 340 having the horizontal polarizing axis. However, the horizontally polarized ray may be substantially blocked by the first inner polarizing layer 460 having the vertical polarizing axis.

The front light sequentially passes through the second transparent layer 305, the color pixel layer 320 and the common electrode 330 that are included in the color filter substrate 300. The front light then incident on the second inner polarizing layer 340.

The second inner polarizing layer 340 provides the liquid crystal layer 200 with the horizontally polarized ray included in the front light. To display white, the liquid crystal layer 200 delays a wavelength of the horizontally polarized ray by about λ/2 to change the horizontally polarized ray into the vertically polarized ray and then provides the pixel electrode layer 450 with the vertically polarized ray. To display black, the horizontally polarized ray may pass through the liquid crystal layer 200 without a delay of the wavelength so that the horizontally polarized ray may be incident on the pixel electrode layer 450.

When a potential difference is not applied to the liquid crystal layer 200, the liquid crystal layer 200 delays the wavelength of the horizontally polarized ray by about λ/2 to change the horizontally polarized ray into the vertically polarized ray. Thereafter, the vertically polarized ray then passes through the pixel electrode layer 450 and the first inner polarizing layer 460. Sequentially, vertically polarized ray may be reflected on the reflection layer 140. Thereafter, the vertically polarized ray may sequentially pass through the first inner polarizing layer 460 and the pixel electrode layer 450. The liquid crystal layer 200 then delays the wavelength of the vertically polarized ray by about λ/2 to change the vertically polarized ray into the horizontally polarized ray. Sequentially, the horizontally polarized ray passes through the second inner polarizing layer 340, the common electrode layer 330, the color pixel layer 320 and the second transparent layer 305. Thus, the transmissive and reflective LCD panel 2000 may display white.

If an electric potential difference is applied to the liquid crystal layer 200, the second inner polarizing layer 340 provides the liquid crystal layer 200 with the horizontally polarized ray. Then, the horizontally polarized ray may pass through the liquid crystal layer 200 without the delay of the wavelength so that the vertically polarized ray may be incident on the pixel electrode layer 450. Thereafter, the vertically polarized ray passes through the pixel electrode layer 450. Subsequently, the vertical polarized ray is incident on the first inner polarizing layer 160. Because the horizontally polarized ray may not pass through the first inner polarizing layer 460 having the vertical polarizing axis, the transmissive and reflective LCD panel 2000 may display black.

In FIG. 4, the transmissive and reflective type LCD panel is illustrated as an LCD panel. However, other configurations of an LCD panel may be used. For example, a transmissive type LCD or a reflective LCD panel may be used as the LCD panel. The transmissive type LCD may omit the reflection layer. On the other hand, the reflective type LCD may include a reflection layer corresponding to an entire pixel area.

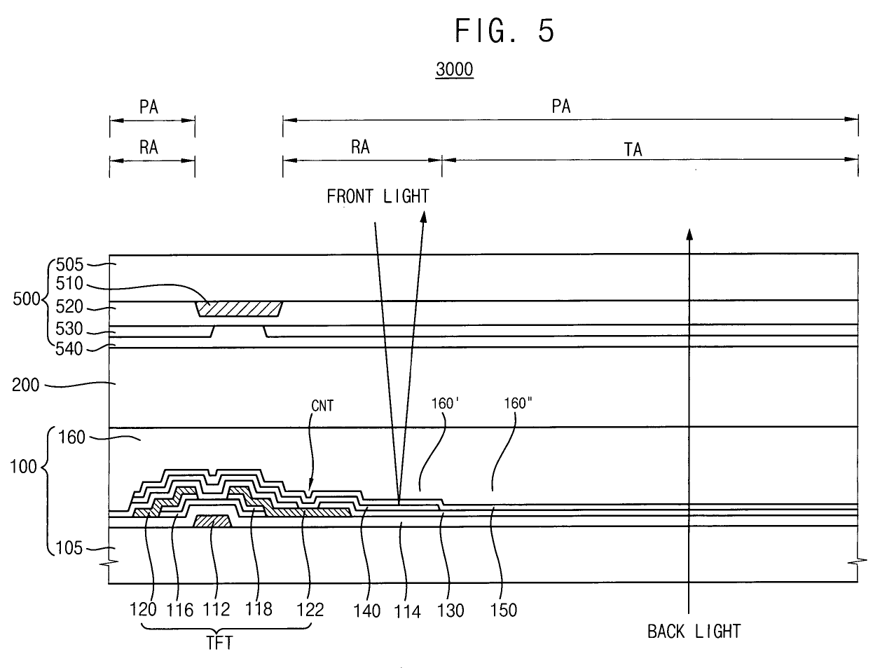

FIG. 5 is a cross-sectional view illustrating a transmissive and reflective type LCD panel having a dual thickness inner polarizing layer. In particular, a liquid crystal layer included in the transmissive and reflective type liquid crystal display (LCD) panel has a substantially uniform thickness. That is, the liquid crystal layer has a single cell-gap. The liquid crystal layer is positioned between a substantially even upper face of a first inner polarizing layer and a substantially even lower face of a second inner polarizing layer. The first and second inner polarizing layers are included in the transmissive and reflective type liquid crystal display (LCD) panel.

As shown in FIG. 5, transmissive and reflective LCD panel 3000 is substantially identical to that already illustrated in FIG. 1 except for a color filter substrate 500. Thus, the same reference numerals will be used to refer to the same or like parts as those described in FIG. 1 and repetitive explanation thereof may be omitted.

Referring to FIG. 5, a transmissive and reflective type LCD panel 3000 includes a color filter substrate 500. The color filter substrate 500 includes a second transparent layer 505, a light blocking layer 510, a second inner polarizing layer 520, a color pixel layer 530 and a common electrode layer 540.

The light blocking layer 510 is formed beneath the transparent layer 505 to define a pixel area PA. The second inner polarizing layer 520 is formed beneath the light blocking layer 510 and the second transparent layer 505. The color pixel layer 530 is formed beneath the second inner polarizing layer 520. The color pixel layer 530 corresponds to the pixel area PA. The common electrode layer 540 is formed beneath the color pixel layer 530 and the second inner polarizing layer 520 so that the color pixel layer 530 and the second inner polarizing layer 520 may be covered with the common electrode layer 540.

The color filter substrate 500 is connected to an array substrate 100 so that a liquid crystal layer 200 may be received between the color filter substrate 500 and the array substrate 100.

Although not illustrated in FIG. 5, the color filter substrate 500 may include an over-coating layer. The over-coating layer may be formed beneath the color pixel layer 530.

The first polarizing layer 160 and the second polarizing layer 340 have a first polarizing axis and a second polarizing axis, respectively. The first polarizing axis may be substantially perpendicular to the second polarizing axis. For example, when the first polarizing axis is a vertical polarizing axis, the second polarizing axis may be a horizontal axis.

Hereinafter, an operation of the transmissive and reflective type LCD panel 3000 is described. The operation of the transmissive and reflective type LCD panel 3000 may include a transmission mode operation and a reflection mode operation. When a voltage is not applied to the liquid crystal layer 200, the transmissive and reflective type LCD panel 3000 displays white. That is, the transmissive and reflective type LCD panel 3000 may operate in a normally white mode. The first inner polarizing layer 160 may have a vertical polarizing axis, while the second inner polarizing layer 520 may have a horizontal axis.

Transmission Mode Operation

A back light is incident on a rear face of the transmissive and reflective LCD panel 1000. The back light includes a vertically polarized ray and a horizontally polarized ray.

The vertically polarized ray may be substantially transmitted through the first inner polarizing layer 160 having the vertical polarizing axis. However, the vertically polarized ray may be substantially blocked by the second inner polarizing layer 520 having the horizontal polarizing axis.

On the other hand, the horizontally polarized ray may be substantially transmitted through the second inner polarizing layer 520 having the horizontal polarizing axis. However, the horizontally polarized ray may be substantially blocked by through the first inner polarizing layer 160 having the vertical polarizing axis.

The first inner polarizing layer 160 included in the array substrate 100 provides the liquid crystal layer 200 with the vertically polarized ray of the back light. To display white, the liquid crystal layer 200 delays a wavelength of the vertically polarized ray by about λ/2 to change the vertically polarized ray into the horizontally polarized ray and then provides the common electrode layer 540 with the horizontally polarized ray. To display black, the vertically polarized ray may pass through the liquid crystal layer 200 without a delay of the wavelength so that the vertically polarized ray may be incident on the common electrode layer 540.

When a potential difference is not applied to the liquid crystal layer 200, the liquid crystal layer 200 delays the wavelength of the vertically polarized ray by about λ/2 to change the vertically polarized ray into the horizontally polarized ray. The horizontally polarized ray sequentially passes through the common electrode layer 540, the color pixel layer 530, the second inner polarizing layer 520 and the second transparent layer 305. As a result, the transmissive and reflective LCD panel 1000 may display white.

If an electric potential difference is applied to the liquid crystal layer 200, the vertically polarized ray may pass through the liquid crystal layer 200 without the delay of the wavelength so that the vertically polarized ray may be incident on the common electrode layer 540. Thereafter, the vertically polarized ray passes through the common electrode layer 540 and the color pixel layer 530. Sequentially, the vertically polarized ray is incident on the second inner polarizing layer 520. Because the vertically polarized ray is substantially blocked by the second inner polarizing layer 520 having the horizontal polarizing axis, the transmissive and reflective LCD panel 3000 may display black.

Reflection Mode Operation

In reflection mode, front light is incident on a front face of the transmissive and reflective LCD panel 3000. The front light includes a vertically polarized ray and a horizontally polarized ray.

The vertically polarized ray may be substantially transmitted through the first inner polarizing layer 160 having the vertical polarizing axis. However, the vertically polarized ray may be substantially blocked by the second inner polarizing layer 520 having the horizontal polarizing axis.

On the other hand, the horizontally polarized ray may be substantially transmitted through the second inner polarizing layer 520 having the horizontal polarizing axis. However, the horizontally polarized ray may be substantially blocked by the first inner polarizing layer 160 having the vertical polarizing axis.

The front light passes through the second transparent layer 505. The front light is then incident on the second inner polarizing layer 520. The second inner polarizing layer 520 provides the color pixel layer 530 with the horizontally polarized ray included in the front light. The horizontally polarized ray then passes through the color pixel layer 530 and the common electrode layer 540. Sequentially, the horizontally polarized ray is incident on the liquid crystal layer 200. To display white, the liquid crystal layer 200 delays a wavelength of the horizontally polarized ray by about λ/2 to change the horizontally polarized ray into the vertically polarized ray and then provides the first inner polarizing layer 160 with the vertically polarized ray. To display black, the horizontally polarized ray may pass through the liquid crystal layer 200 without a delay of the wavelength so that the horizontally polarized ray may be incident on the first inner polarizing layer 160.

If an electric potential difference is not applied to the liquid crystal layer 200, the liquid crystal layer 200 delays the wavelength of the horizontally polarized ray by about λ/2 to change the horizontally polarized ray into the vertically polarized ray. Thereafter, the vertically polarized ray sequentially passes through the first inner polarizing layer 160 and the pixel electrode layer 150. The vertically polarized ray may be then reflected on the reflection layer 140. Thereafter, the vertically polarized ray sequentially passes through the pixel electrode layer 150 and the first inner polarizing layer 160 so that the vertically polarized ray may be incident on the liquid crystal layer 200. The liquid crystal layer 200 then delays the wavelength of the vertically polarized ray by about λ/2 to change the vertically polarized ray into the horizontally polarized ray. Thereafter, the horizontally polarized ray sequentially passes through the common electrode layer 540, the color pixel layer 530 and the second inner polarizing layer 520. As a result, the transmissive and reflective LCD panel 3000 may display white.

If an electric potential difference is applied to the liquid crystal layer 200, the second inner polarizing layer 520 provides the color pixel layer 530 with the horizontally polarized ray. The horizontally polarized ray then passes through the color pixel layer 530 and the common electrode layer 540 so that the horizontally polarized ray may be incident on the liquid crystal layer 200. Thereafter, the horizontally polarized ray passes through the liquid crystal layer 200 without the delay of the wavelength so that the vertically polarized ray may be incident on the first inner polarizing layer 160. Because the horizontally polarized ray may not pass through the first inner polarizing layer 160 having the vertical polarizing axis, the transmissive and reflective LCD panel 3000 may display black.

In FIG. 5, the transmissive and reflective type LCD panel is illustrated as an LCD panel. However, other configurations of an LCD panel may be used. For example, a transmissive type LCD or a reflective LCD panel may be used as the LCD panel. The transmissive type LCD may omit the reflection layer. On the other hand, the reflective type LCD may include a reflection layer corresponding to an entire pixel area.

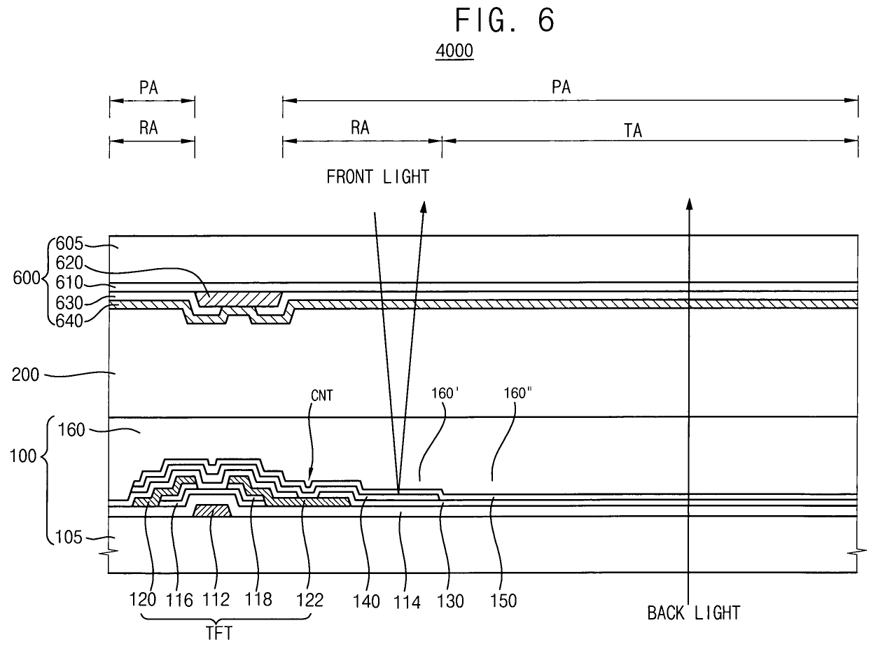

FIG. 6 is a cross-sectional view illustrating a transmissive and reflective type LCD panel having a dual thickness inner polarizing layer in accordance with an exemplary embodiment of the present invention. In particular, a liquid crystal layer included in the transmissive and reflective type liquid crystal display (LCD) panel has a substantially uniform thickness. That is, the liquid crystal layer may have a single cell-gap. The liquid crystal layer is positioned between a substantially even upper face of a first inner polarizing layer and a substantially even lower face of a second inner polarizing layer. The first and second inner polarizing layers are included in the transmissive and reflective type LCD panel.

A transmissive and reflective LCD panel 4000 is substantially identical to that already illustrated in FIG. 1 except for a color filter substrate 600. Thus, the same reference numerals will be used to refer to the same or like parts as those described in FIG. 1 and repetitive explanation thereof may be omitted.

Referring to FIG. 6, a transmissive and reflective type LCD panel 4000 includes a color filter substrate 600. The color filter substrate 600 includes a second transparent layer 605, a second inner polarizing layer 610, a light blocking layer 620, a color pixel layer 630 and a common electrode layer 640.

The second inner polarizing layer 610 is formed beneath the second transparent layer 605. The light blocking layer 620 is formed beneath the second inner polarizing layer 610. The color pixel layer 630 is formed beneath the second inner polarizing layer 610 and the light blocking layer 620. The common electrode layer 640 is formed beneath the light blocking layer 620 and the color pixel layer 630 so that the light blocking layer 620 and the color pixel layer 630 may be covered with the common electrode layer 640.

The color filter substrate 600 is connected to an array substrate 100 so that a liquid crystal layer 200 may be received between the color filter substrate 600 and the array substrate 100.

Although not illustrated in FIG. 6, the color filter substrate 600 may include an over-coating layer. The over-coating layer may be formed beneath the color pixel layer 630.

A first polarizing layer 160 has a first polarizing axis, while the second polarizing layer 340 has a second polarizing axis. The first polarizing axis may be substantially perpendicular to the second polarizing axis. For example, in case that the first polarizing axis is a vertical polarizing axis, the second polarizing axis may be a horizontal axis.

Hereinafter, one method of operation of the transmissive and reflective type LCD panel 4000 is described. The operation of the transmissive and reflective type LCD panel 4000 may include a transmission mode operation and a reflection mode operation. When a voltage is not applied to the liquid crystal layer 200, the transmissive and reflective type LCD panel 4000 displays white. That is, the transmissive and reflective type LCD panel 4000 may operate in a normally white mode. The first inner polarizing layer 160 may have a vertical polarizing axis, while the second inner polarizing layer 610 may have a horizontal polarizing axis.

Transmission Mode Operation

A back light is incident on a rear face of the transmissive and reflective LCD panel 1000. The back light includes a vertically polarized ray and a horizontally polarized ray.

The vertically polarized ray may be substantially transmitted through the first inner polarizing layer 160 having the vertical polarizing axis. However, the vertically polarized ray may be substantially blocked by the second inner polarizing layer 610 having the horizontal polarizing axis.

On the other hand, the horizontally polarized ray may be substantially transmitted through the second inner polarizing layer 610 having the horizontal polarizing axis. However, the horizontally polarized ray may not pass through the first inner polarizing layer 160 having the vertical polarizing axis.

The first inner polarizing layer 160 included in the array substrate 100 provides the liquid crystal layer 200 with the vertically polarized ray of the back light. To display white, liquid crystal layer 200 delays a wavelength of the vertically polarized ray by about λ/2 to change the vertically polarized ray into the horizontally polarized ray and then provides the common electrode layer 640 with the horizontally polarized ray. To display black, the vertically polarized ray may pass through the liquid crystal layer 200 without a delay of the wavelength so that the vertically polarized ray may be incident on the common electrode layer 640.

When a potential difference is not applied to the liquid crystal layer 200, the liquid crystal layer 200 delays the wavelength of the vertically polarized ray by about λ/2 to change the vertically polarized ray into the horizontally polarized ray. The horizontally polarized ray sequentially passes through the common electrode layer 640, the color pixel layer 630, the second inner polarizing layer 610 and the second transparent layer 605. As a result, the transmissive and reflective LCD panel 4000 may display white.

If an electric potential difference is applied to the liquid crystal layer 200, the vertically polarized ray may pass through the liquid crystal layer 200 without the delay of the wavelength so that the vertically polarized ray may be incident on the common electrode layer 640. Thereafter, the vertically polarized ray passes through the common electrode layer 640 and the color pixel layer 630. The vertically polarized ray is then incident on the second inner polarizing layer 610. Because the vertically polarized ray is substantially blocked by the second inner polarizing layer 610 having the horizontal polarizing axis, the transmissive and reflective LCD panel 4000 may display black.

Reflection Mode Operation

In reflection mode, front light is incident on a front face of the transmissive and reflective LCD panel 4000. The front light includes a vertically polarized ray and a horizontally polarized ray.

The vertically polarized ray may be substantially transmitted through the first inner polarizing layer 160 having the vertical polarizing axis. However, the vertically polarized ray may be substantially blocked by the second inner polarizing layer 610 having the horizontal polarizing axis.

On the other hand, the horizontally polarized ray may be substantially transmitted through the second inner polarizing layer 610 having the horizontal polarizing axis. However, the horizontally polarized ray may be substantially blocked by the second inner polarizing layer 160 having the vertical polarizing axis.

The front light passes through the second transparent layer 605. The front light is then incident on second inner polarizing layer 610. The second inner polarizing layer 610 provides the color pixel layer 630 with the horizontally polarized ray included in the front light. The horizontally polarized ray then passes through the color pixel layer 630 and the common electrode layer 640. Subsequently, the horizontally polarized ray is incident on the liquid crystal layer 200. To display white, the liquid crystal layer 200 delays a wavelength of the horizontally polarized ray by about λ/2 to change the horizontally polarized ray into the vertically polarized ray and then provides the first inner polarizing layer 160 with the vertically polarized ray. To display black, the horizontally polarized ray may pass through the liquid crystal layer 200 without a delay of the wavelength so that the horizontally polarized ray may be incident on the first inner polarizing layer 160.

When an electric potential difference is not applied to the liquid crystal layer 200, the liquid crystal layer 200 delays the wavelength of the horizontally polarized ray by about λ/2 to change the horizontally polarized ray into the vertically polarized ray. Thereafter, the vertically polarized ray sequentially passes through the first inner polarizing layer 160 and the pixel electrode layer 150. The vertically polarized ray may be then reflected on the reflection layer 140. Thereafter, the vertically polarized ray sequentially passes the pixel electrode layer 150 and the first inner polarizing layer 160 so that the vertically polarized ray may be incident on the liquid crystal layer 200. The liquid crystal layer 200 then delays the wavelength of the vertically polarized ray by about λ/2 to change the vertically polarized ray into the horizontally polarized ray. Thereafter, the horizontally polarized ray sequentially passes through the common electrode layer 640, the color pixel layer 630 and the second inner polarizing layer 610. Thus, the transmissive and reflective LCD panel 4000 may display white.

If an electric potential difference is applied to the liquid crystal layer 200, the second inner polarizing layer 610 provides the color pixel layer 630 with the horizontally polarized ray. The horizontally polarized ray then pass through the color pixel layer 630 and the common electrode layer 640 so that the horizontally polarized ray may be incident on the liquid crystal layer 200. Thereafter, the horizontally polarized ray passes through the liquid crystal layer 200 without the delay of the wavelength so that the vertically polarized ray may be incident on the first inner polarizing layer 160. Because the horizontally polarized ray is substantially blocked by the first inner polarizing layer 160 having the vertical polarizing axis, the transmissive and reflective LCD panel 4000 may display black.

In FIG. 6, the transmissive and reflective type LCD panel is illustrated as a LCD panel. However, other configurations of an LCD panel may be used. For example, a transmissive type LCD or a reflective LCD panel may be used as the LCD panel. The transmissive type LCD may omit the reflection layer. On the other hand, the reflective type LCD may include a reflection layer corresponding to an entire pixel area.

A liquid crystal display device including a liquid crystal layer with a reflection portion and a transmission portion having a uniform thickness, may be operated using a method referred to as a “dual gamma” driving method. In the dual gamma driving method, in order to improve a display quality of the liquid crystal layer, a first voltage and a second voltage that is substantially larger than the first voltage are independently applied to the reflection portion and the transmission portion. The dual gamma driving method may compensate for a difference in light path for reflection and transmission modes (e.g., the light path of the front light in the liquid crystal layer may be substantially longer than that of the back light in the liquid crystal layer).

However, destructive interference may occur if the front light incident on the reflection portion is sufficiently intense. Additional integrated circuits (ICs) may then be needed to suppress the destructive interference, and to independently apply the first voltage and the second voltage to the reflection portion and the transmission portion, respectively.

However, according to systems and techniques described herein, the inner polarizing layer may include a first portion and a second portion corresponding to the reflection area and the transmission area, respectively. In addition, the second portion is substantially thicker than the first portion.

Thus, the front light may pass through the first portion of the inner polarizing layer twice. As a result, a light path of the front light in the liquid crystal layer and the inner polarizing layer is substantially identical to that of the back light in the liquid crystal layer in the liquid crystal layer and the inner polarizing layer. Thus, a display quality may be improved.

The liquid crystal display panel of the present invention may be operated by a method substantially similar to the dual gamma driving method. Hereinafter, one example of the method is described.

In case of the transmission mode, a backlight assembly is turned on. In case of the reflection mode, the backlight assembly is turned off. In addition, in the transmission mode, a driving voltage is applied to the liquid crystal layer. The driving voltage is substantially half of a standard voltage. The standard voltage is a voltage that, when applied to the liquid crystal layer including a liquid crystal molecule that is horizontally arranged, will cause the liquid crystal molecule to be vertically arranged. As a result, optical characteristics of the transmission mode may be substantially identical to those of the reflection mode. The optical characteristic may be expressed as “Δnd”.

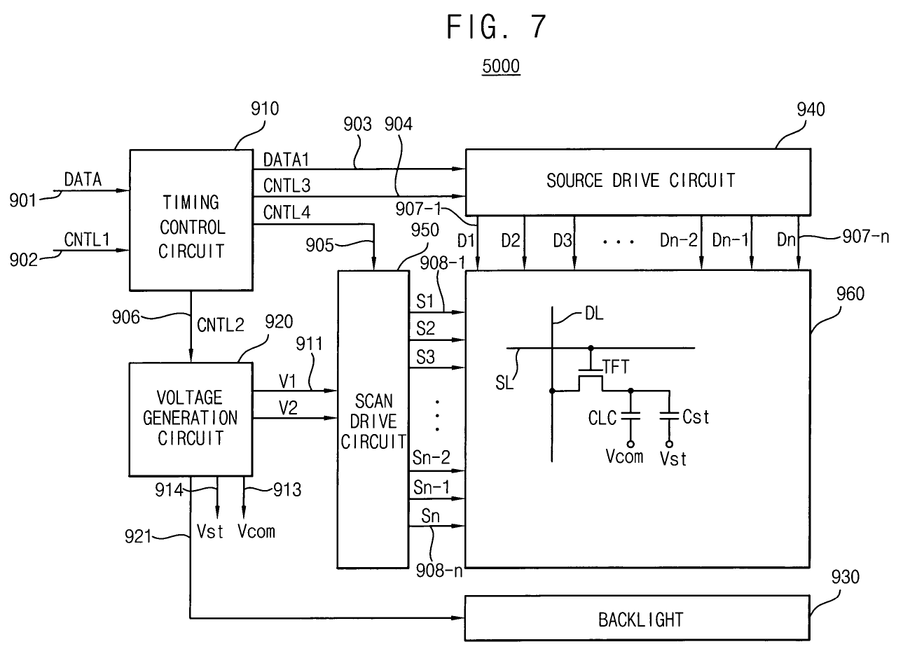

FIG. 7 is a block diagram illustrating an LCD device in accordance with an exemplary embodiment of the present invention. The LCD device may be operated by a dual gamma driving method.

Referring to FIG. 7, an LCD device includes a timing control circuit 910, a voltage generator circuit 920, a backlight 930, a data drive circuit 940, a scan drive circuit 950 and an LCD panel 960.

For a transmissive mode, the backlight 930 is turned on. For a reflective mode, the backlight 930 is turned off.

For the transmissive mode, the voltage generator circuit 920 generates a first voltage. For the reflective mode, the voltage generator circuit 920 generates a second voltage. The second voltage may be substantially half the first voltage.

A first image signal DATA on lead 903 and a first control signal CNTL1 on lead 902 are supplied to the timing control circuit 910. The first control signal CNTL1 received on lead 902 may be used for an output of the first image signal DATA on lead 903. The timing control circuit 910 provides the voltage generator circuit 920 with a second control signal CNT2 on lead 906. The timing control circuit 910 provides a source drive circuit 940 with a second image signal DATA1 on lead 903 and a third control signal CNT3 on lead 904. The third control signal CNT3 may be used for an output of the second image signal DATA1. The timing control circuit 910 provides the scan drive circuit 950 with a fourth control signal CNT4, such as a scan start signal STV, on lead 905. The scan drive circuit 950 may comprise a scan driver.

For the transmissive mode, the timing control circuit 910 may turn on the backlight 930. For the reflective mode, the timing control circuit 910 provides the voltage generator circuit 930 with the second control signal CNT2 used for turning off the backlight 930. In addition, the timing control circuit 910 provides the source drive circuit 940 with the third control signal CNT3. The third control signal CNT3 is used for an output of the second image signal DATA1. Thus, for the transmissive mode, the voltage generator circuit 920 generates the first voltage. For the reflective mode, the voltage generator circuit 920 generates the second voltage substantially half of the first voltage.

The second control signal CNT2 is applied to the voltage generator circuit 920 over lead 906. The voltage generator circuit 920 provides the scan drive circuit 950 with the first voltage and the second voltage that are used for a gate-on and a gate-off. In addition, the voltage generator circuit 920 provides the LCD panel 960 with a common electrode voltage Vcom over lead 913 and a storage voltage Vst over a lead 914. Furthermore, the voltage generator circuit 920 provides the backlight 930 with a backlight turn on/off voltage over lead 921.

When the backlight on/off voltage supplied from the voltage generator circuit 920 turns on the backlight 930, the backlight 930 may provide the LCD panel 960 with a back light. In detail, in case of the transmissive mode, the backlight 930 provides the LCD panel 960 with the back light. In case of the reflective mode, the backlight 930 is turned off.

The source drive circuit 940 inverts the second image signal DATA1 into the analog signal using the third control signal CNTL 3. The source drive circuit 940 defines the analog signal as data signals D1, D2, . . . , Dn-1 and Dn. Sequentially, the source drive circuit 940 provides the LCD panel 960 with the data signals D1, D2, . . . , Dn-1 and Dn over leads 907-1 to 907-n.

The scan drive circuit 950 sequentially outputs scan signals S1, S2, . . . , Sn-1 and Sn by using a fourth control signal CNTL4, the first voltage, the second voltage, a first bias voltage VDD and a second bias voltage GND. The fourth control signal CNT4 is supplied from the timing control circuit 910 over lead 905. The first and second voltages V1 and V2 are supplied from the voltage generator circuit 920 on leads 911 and 912, respectively.

The scan drive circuit 950 may include a flexible printed circuit board (FPCB) including a driver integrated circuit (IC).

As one alternative, the scan drive circuit 950 may include a printed circuit board (PCB) and a flexible printed circuit board (FPCB). The FPCB includes a driver integrated circuit (IC). In addition, the FPCB connects the PCB to a scan line SL of the LCD panel 960.

As another alternative, the scan drive circuit 950 may be connected to a scan line during a formation of a thin film transistor without an aid of a FPCB.

The LCD panel 960 includes a plurality of data lines DL, a plurality of scan lines SL and pixel portions. The data lines DL cross with the scan lines SL. In addition, the data lines DL are electrically insulated from the scan lines SL. The data lines DL and the scan lines SL together define pixel areas in which the pixel portions are formed.

The pixel portion includes the TFT, a liquid crystal capacitor CLC and a storage capacitor Cst. The TFT includes a gate electrode, a source electrode and a drain electrode. The gate electrode is electrically connected to the scan line. The source electrode is electrically connected to the data line. The liquid crystal capacitor CLC and the storage capacitor Cst are electrically connected to the drain electrode.

According to the present disclosure, an inner polarizing layer is formed inside an LCD panel so that the LCD panel may be efficiently manufactured. That is, the number of processes required for manufacturing the LCD device may decrease.

Additionally, quality testing of liquid crystal cells prior to attaching an inner polarizing layer to the array substrate or color filter substrate may be omitted, since the inner polarizing layer is attached to the array substrate or color filter substrate during substrate manufacturing. In addition, the quality test may be performed after a cutting process and an attaching process to attach the inner polarizing layer to the array substrate or the color filter substrate. As a result, a module process may be efficiently performed on the array substrate and the color filter substrate.

In addition, because the inner polarizing layer is directly attached to the array substrate or the color filter substrate, a large size LCD device may be efficiently manufactured. In addition, yield of the LCD devices may increase.

Furthermore, because a reflection mode and a transmission mode are independently operated, both a reflection mode characteristic and a transmission characteristic may be improved.

In addition, because the inner polarizing layer may be formed by a slot die coating process, an inner polarizing layer having a substantially even upper face may be efficiently formed. Thus, an additional process for planarizing the upper face of the inner polarizing layer may not be required. In addition, an additional layer formed on an irregular upper face may not be required.

Furthermore, upper structures may be selectively formed over a reflection area of a first transparent layer with which the inner polarizing layer is covered. Thus, the inner polarizing layer having a first portion and the second portion that is substantially thicker than the first portion is efficiently formed. Here, the first portion is where a front light is reflected. The second portion is through which a back light passes.

In addition, the array substrate or the color filter substrate is coated with the inner polarizing layer, a compensating film required for improving a display quality may not be required. Thus, the manufacturing cost of the LCD device may decrease.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. An array substrate comprising:
a transparent substrate having a pixel area, the pixel area including a reflection area and a transmission area;
a pixel electrode layer corresponding to the pixel area, the pixel electrode layer configured to receive a pixel voltage; and
an inner polarizing layer positioned proximate to the pixel electrode layer, the inner polarizing layer comprising a first portion positioned proximate to the reflection area of the pixel area, the inner polarizing layer further comprising a second portion positioned proximate to the transmission area of the pixel area, wherein the second portion is substantially thicker than the first portion.

2. The array substrate of claim 1, wherein the inner polarizing layer comprises a material having a light transparency that is substantially in proportion to a thickness of the material and substantially in inverse proportion to a contrast ratio of the material.

3. The array substrate of claim 1, wherein the inner polarizing layer has a substantially even upper face.

4. The array substrate of claim 1, further comprising:
a reflection layer proximate to the reflection area of the pixel area;
a switching device; and
wherein the reflection layer is electrically connected to the switching device, and wherein the pixel electrode layer is electrically connected to the reflection layer.

5. The array substrate of claim 4, wherein the pixel electrode layer comprises at least a portion formed over the transmission area.

6. The array substrate of claim 5, wherein the inner polarizing layer comprises at least a portion formed over the pixel electrode layer and the reflection layer.

7. The array substrate of claim 4, wherein the pixel electrode layer comprises at least a portion formed over the transmission area and the reflection area.

8. The array substrate of claim 7, wherein the inner polarizing layer comprises at least a portion formed over the pixel electrode layer.

9. The array substrate of claim 7, wherein the inner polarizing layer comprises at least a portion formed under the pixel electrode layer.

10. The array substrate of claim 4, wherein the switching device includes a gate electrode and a source-drain electrode, at wherein at least a portion of the inner polarizing layer is formed over the gate electrode.

11. The array substrate of claim 4, wherein the switching device includes a gate electrode and a source-drain electrode, and wherein at least a portion of the inner polarizing layer is formed over the source-drain electrode.

12. The array substrate of claim 1, wherein the first portion of the inner polarizing layer has a first thickness of about 0.4 μm to about 0.6 μm, and the second portion of the inner polarizing layer has a second thickness of about 0.8 μm to about 1.2 μm.

13. A color filter substrate comprising:
a transparent layer having a pixel area comprising a reflection area and a transmission area;
a color pixel layer formed under the transparent layer, the color pixel layer corresponding to the pixel area; and
an inner polarizing layer positioned proximate to the color pixel layer, the inner polarizing layer having a substantially even lower face.

14. The color filter substrate of claim 13, wherein the inner polarizing layer comprises a material having a light transparency that is substantially in proportion to a thickness of the material and substantially in inverse proportion to a contrast ratio of the material.

15. The color filter substrate of claim 13, further comprising a common electrode layer formed under the color pixel layer; and
wherein at least a portion of the inner polarizing layer is formed under the common electrode layer.

16. The color filter substrate of claim 13, further comprising a light blocking layer defining at least one boundary of the pixel area; and
wherein the inner polarizing layer is formed under the light blocking layer and the transparent layer.

17. The color filter substrate of claim 16, further comprising a common electrode layer; and
wherein the color pixel layer is formed under the inner polarizing layer, the common electrode layer being formed under the color pixel layer.

18. The color filter substrate of claim 13, further comprising a light blocking layer formed under the inner polarizing layer; and
wherein the inner polarizing layer is formed under the transparent layer.

19. A liquid crystal display panel comprising:
a first substrate including a first transparent layer, a pixel electrode, a reflection layer and a first inner polarizing layer, the first transparent layer having a pixel area divided into a reflection area and a transmission area, the pixel electrode layer corresponding to the pixel area, the reflection layer corresponding to the reflection area, the first inner polarizing layer corresponding to the pixel electrode layer and the reflection layer, the first inner polarizing layer having a first portion and a second portion, the first portion corresponding to the reflection area, the second portion corresponding to the reflection area, the second portion being substantially thicker than the first portion;
a liquid crystal layer; and
a second substrate including a second transparent layer and a second inner polarizing layer, the second inner polarizing layer corresponding to the pixel area, the second substrate being combined with the first substrate to receive the liquid crystal layer between the first substrate and the second substrate.

20. The liquid crystal display panel of claim 19, wherein the liquid crystal layer has a uniform thickness.

21. A display apparatus comprising:
a first pixel region of the display apparatus, the first pixel region including a reflection region and a transmission region;
a first pixel electrode included in the first pixel region, the first pixel electrode configured to provide a pixel voltage of a pixel voltage difference across a display material, wherein at least one display characteristic of the display material is different for a first pixel potential difference and a second pixel potential difference;
a polarizing layer of the first pixel region, the polarizing layer including a first portion included in the reflection region of the first pixel region and a second portion included in the transmission region of the first pixel region, wherein the polarizing layer of the first pixel region has a first thickness in the reflection region of the first pixel region and a second thickness greater than the first thickness in the transmission region of the first pixel region.

22. The apparatus of claim 21, further including the display material, and wherein the display material comprises a liquid crystal material.

23. The apparatus of claim 21, wherein the polarizing layer has a substantially even surface.

24. The apparatus of claim 23, wherein the polarizing layer is a coated layer formed on at least one underlying structure of the apparatus, the at least one underlying structure having an uneven upper boundary.

25. The apparatus of claim 24, wherein the polarizing layer is a slot coated layer.

26. The apparatus of claim 21, wherein the polarizing layer comprises an anisotropic polarizing material.
